(19) United States
(12) Patent Application Publication
(10) Pub. No.: US 2015/0321770 A1
(43) Pub. Date: Nov. 12, 2015

(54) New method to prevent or stop an airplane from being hijacked and to minimize the effect of damage by using remote and wireless real-time monitoring and inhalational general anesthetic gases controlled from the ground (level)

(71) Applicant: Davy Zide Qian, Arcadia, CA (US)

(72) Inventor: Davy Zide Qian, Arcadia, CA (US)

(21) Appl. No.: 14/642,741

(22) Filed: Jun. 19, 2015

Related U.S. Application Data
(60) Provisional application No. 61/950,216, filed on Mar. 10, 2014.
(60) Provisional application No. 61/950,156, filed on Mar. 9, 2014.

(51) Int. Cl. B64D 45/00

(52) U.S. Cl. CPC B64D 45/0015; B64D 2045/0025; B64D 2045/0035

(57) ABSTRACT

A method to stop hijack of an airplane, installs video monitors, audio monitors and a gas delivery system in passenger cabins, a cockpit and needed places. The gas is inhalational general anesthetic which make people into a deep sleep. During cruise video and audio signals of the video and audio monitors are sent to a ground control center by radio for monitoring. When a hijack is happened and cannot stopped the ground control center issues a gassing order to the gas delivery system or pilots to discharge gas inhalational general anesthetic and the airplane is returned to a near airport by pilots or an auto driving system.

### CROSS REFERENCE TO RELATED PATENT APPLICATION

The present application claims a priority of the U.S. Provisional Application No. 61/950,216 filed on Mar. 10, 2014 and U.S. Provisional Application No. 61/950,156 filed on Mar. 9, 2014, which application is incorporated herein by reference.

### BACKGROUND OF THE INVENTION

When an airplane gets hijacked the effect can be devastating, the hijacked plane can be used as huge bomb to hit big building, airport, water dam or nuclear power plant, etc. Once the plane is hijacked, there is not much people can do. But this new method is to prevent/stop a total hijack and/or to minimize the damage.

### DETAIL DESCRIPTION OF THE INVENTION

First, the passenger cabin, as well as the cockpit need to be closely monitored and recorded by many video as well as audio monitors to cover every corner for any abnormal activities, the recording can be saved in the “Black Box” in the traditional way; but meanwhile the monitored video and audio signals/information inside the plane (in both passenger cabin as well as cockpit since any pilot can be a terrorist also) should be encrypted and broadcasted and/or transmitted, in real-time, by radio wirelessly to a ground level (security) control department/unit or a governmental security agency for monitoring and recording. If the flight arrives at the destination safely and un-eventfully, then the recordings can be destroyed for privacy purposes.

Also, the airplane has to be pre-fitted or pre-installed with a built-in gas delivery equipment or system that can deliver, and blow certain inhalational general anesthetic gases (such as nitrous oxide, cyclopropane and xenon, etc.) into the passenger cabin and/or pilot cockpit to put people inside the plane into a deep sleep when it's necessary—the operation or activation of this gas delivery system (while the airplane is in mid-air) can be controlled, remotely and wirelessly (via radio), by the ground level (security) control unit personnel or the governmental security agency. The pilot(s) may also be granted with the control over this gas delivery system if the pilot is trusted, in a manual way or with a remote control; but the pilot's control over the gas delivery system can be overridden by the ground level (security) control unit, just in case the pilot becomes overwhelmed by the terrorists.

During the flight, while the ground level control unit personnel (situated somewhere at ground level) monitors the video and audio information inside the passenger cabin and/or the cockpit sent to them via radio, if anything abnormal happens and if it is determined that the air-plane has been hijacked or taken over by the terrorists (or in the process of that), then the ground level control unit or governmental security agency can decide to, remotely and wirelessly via radio, activate the said built-in and preinstalled gas delivery system on the airplane which can fill or blow certain inhalational general anesthetic gases (such as nitrous oxide, cyclopropane and xenon, etc.) into the passenger cabin and/or the cockpit (as needed) to put everybody into a deep sleep and basically neutralize the terrorists without killing anybody.

Then the ground level control unit can also activate, remotely and wirelessly via radio, the auto-pilot function for the airplane (while disabling any manual operation of the plane, just in case) and steer the airplane to an appropriate place for safe landing.

Another fringe benefit can be that there is no longer a need to search into the deep sea to find the “Black Box” any more since everything (both video and audio information) can be encrypted and transmitted wirelessly by radio in high density format from the airplane to a ground control unit and/or governmental security agency to be seen/monitored and recorded for future use just in case. But for privacy reasons, if the airplane lands safely and uneventfully then the recording can be destroyed at some point. This can also save very high cost to locate and retrieve the “Black Box”.

Additionally, all the controls done to the flying plane in mid-air by the ground level security control department/unit (over the flying plane) are achieved in a remote and wireless way via radio control with encryption, similar to how a pilot-less drone is operated.

What is claimed is:

1. A method to stop hijack of an airplane comprising:
a) installing video monitors and audio monitors to cover every corner in passenger cabins, a cockpit and monitoring needed places;
b) installing gas delivery system in the passenger cabins, cockpit and monitoring needed places for delivering gases inhalational general anesthetic which make people into a deep sleep;
c) during cruise video and audio signals of the video and audio monitors being transmitted to a ground control center through radio;
d) the ground control center monitoring received video and audio signals of the video and audio monitors, when a hijack is happened and cannot be stopped the ground control center issues a gassing order to the gas delivery system to discharge gases inhalational general anesthetic;
e) the airplane is returned to a near airport by pilots or an auto driving system.

2. The method of claim 1, wherein the gassing order is issued to pilots in the cockpit when pilots are faithful, pilots carries out the gassing order for the passenger cabins and needed places.

3. The method of claim 1, wherein the gassing order is issued to the gas delivery system when a pilot is relating to the hijack or is hijacked, the delivery system carries out the gassing order directly for the passenger cabins, cockpit and needed places.

4. The method of claim 1, wherein video and audio signals transmitted to the ground control center are transmitted to a black box in meantime.

5. The method of claim 1, wherein gases inhalational general anesthetic are nitrous oxide, cyclopropane and xenon.

6. The method of claim 1, wherein the video and audio signals and the gassing order are encryption.

7. The method of claim 1, wherein the video and audio signals are destroyed if no hijack is happen.
